(19) United States
(12) Patent Application Publication
(10) Pub. No.: US 2011/0287245 A1
(43) Pub. Date: Nov. 24, 2011

(54) WATER-RESISTANT SILICA-EMBEDDED TEXTILES

(76) Inventors: Ali Shamei, Tehran (IR); Mazeyar Parvinzadeh, Tehran (IR); Farbod Alimohammadi, Tehran (IR)

(21) Appl. No.: 13/175,846

(22) Filed: Jul. 2, 2011

(51) Int. Cl. B05D 3/10; B32B 5/02; B01J 19/10

(52) U.S. Cl. 428/221; 427/394; 427/560

(57) ABSTRACT

Water-resistant silica-embedded textiles and methods for production of water-resistant silica-embedded textiles are disclosed. Initially, a silica colloidal solution including hydrophobic fumed silica nanoparticles is obtained. A polycarboxylic acid cross-linking agent and a hypophosphite catalyst are mixed in deionized water and the mixture of the polycarboxylic acid cross-linking agent and the hypophosphite catalyst is added to the silica colloidal solution to form a silica padding solution. Next, a textile is treated with the silica padding solution to form a silica-embedded textile. Finally, the silica-embedded textile is cured.

### SPONSORSHIP STATEMENT

This application has been sponsored by the Iranian Nanotechnology Initiative Council, which does not have any rights in this application.

### TECHNICAL FIELD

This application generally relates to textile production, and more particularly relates to water-resistant silica-embedded textiles.

### BACKGROUND

Research on textiles having unique chemical, electrical, and thermal properties has increased in recent years. To obtain these unique properties, textiles can be embedded with various nanoparticles, such as, for example, nanosilver and/or carbon nanotubes. To embed the nanoparticles, different methods have been used, such as dispersing nano-oxides in the textiles, grafting the nanoparticles to the textiles, inorganic sol-gel coating of the nanoparticles on the textiles, layer-by-layer deposition of the nanoparticles on the textiles, and pretreatment of the textiles with corona discharge, irradiation, ultrasound vibration, and/or plasma to enhance embedding.

Silica is one of the most common inorganic products and is used in many nanocomposites. Silica is characterized by its spherical shape, extremely small particle size, and large surface area. To embed silica nanoparticles in textiles, prior techniques relied on, for example, sol-gel coating and layer-by-layer deposition techniques. However, a need exists for a new, more stable method for production of water-resistant silica-embedded textiles.

### SUMMARY

Water-resistant silica-embedded textiles and methods for production of water-resistant silica-embedded textiles are disclosed. Initially, a silica colloidal solution including hydrophobic fumed silica nanoparticles is obtained. A polycarboxylic acid cross-linking agent and a hypophosphite catalyst are mixed in deionized water and the mixture of the polycarboxylic acid cross-linking agent and the hypophosphite catalyst is added to the silica colloidal solution to form a silica padding solution. Next, a textile is treated with the silica padding solution to form a silica-embedded textile. Finally, the silica-embedded textile is cured.

In some implementations, the textile can be scoured using a non-ionic detergent. The silica colloidal solution can be obtained by dispersing the hydrophobic fumed silica nanoparticles in ethanol. The concentration of the hydrophobic fumed silica nanoparticle solution can be 40 g/L. The hydrophobic fumed silica nanoparticles can be dimethyldichlorosilane-treated fumed silica nanoparticles. The hydrophobic fumed silica nanoparticles can have a BET surface area ranging between 100 m²/g and 150 m²/g, an average particle size between 15 nm and 100 nm, and a purity of greater than or equal to 99.8% silica nanoparticles.

In some implementations, the textile can be cotton fabric, the polycarboxylic acid cross-linking agent can be 1,2,3,4-butanetetracarboxylic acid, and the hypophosphite catalyst can be sodium hypophosphite. The ratio of the polycarboxylic acid cross-linking agent to the hypophosphite catalyst can be 3:2.

In some implementations, the textile can be treated with the silica padding solution to form the silica-embedded textile by wet padding the textile with the silica padding solution. The silica-embedded textile can be cured at a temperature greater than or equal to 150° C. The silica colloidal solution and/or the silica padding solution can be sonicated.

A method for production of water-resistant silica-embedded cotton fabrics is also disclosed. Dimethyldichlorosilane-treated hydrophobic fumed silica nanoparticles are dispersed in ethanol to form a silica colloidal solution. The silica colloidal solution is then sonicated. 1,2,3,4-butanetetracarboxylic acid and sodium hypophosphite are mixed in deionized water and the mixture of the 1,2,3,4-butanetetracarboxylic acid and sodium hypophosphite is added to the silica colloidal solution to form a silica padding solution. The silica padding solution is then sonicated. Cotton fabric is wet padded with the silica padding solution to form silica-embedded cotton and then cured at a temperature greater than or equal to 150° C.

Details of one or more implementations of the water-resistant silica-embedded textiles are set forth in the accompanying drawings and the description below. Other aspects that can be implemented will be apparent from the description and drawings, and from the claims.

### DESCRIPTION OF DRAWINGS

FIG. 1 illustrates an example method for production of water-resistant silica-embedded textiles.

FIGS. 2a-f illustrate scanning electron microscopy images of raw cotton and silica-embedded cotton fibres at different magnifications.

FIG. 3 illustrates a graph of the weight loss percentage of raw cotton and silica-embedded cotton at different temperatures.

FIG. 4 illustrates a graph of the reflectance of electromagnetic energy from raw cotton and silica-embedded cotton.

Like reference symbols indicate like elements throughout the specification and drawings.

### DETAILED DESCRIPTION

Water-resistant silica-embedded textiles, such as, for example, hydrophobic silica-embedded cotton fabrics, and methods of producing the water-resistant silica-embedded textiles are disclosed. Fumed silica can be modified to be hydrophobic and stabilized in the textiles using a cross-linking agent, such as a polycarboxylic acid. As explained in greater detail below, the water-resistant silica-embedded textiles are more flame retardant, thermally stable, reflective, and waterproof than raw textiles.

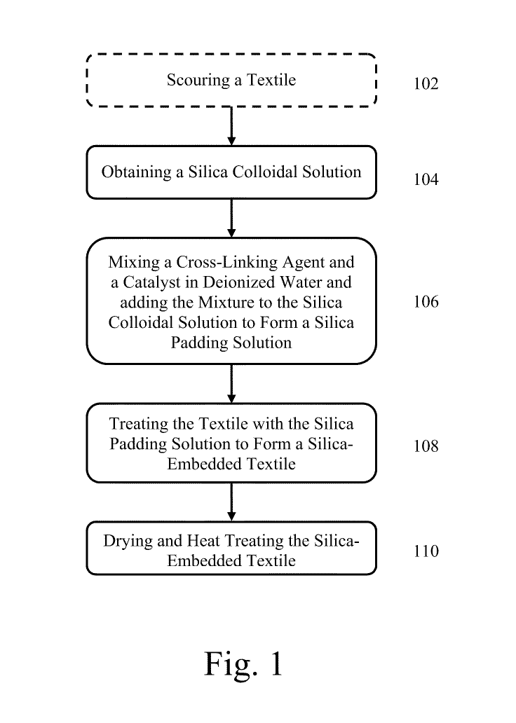

Referring to FIG. 1, a method for production of water-resistant silica-embedded textiles is illustrated. Optionally, a textile can first be scoured using a soap and/or a detergent (step 102). By scouring the textile, natural and/or synthetic impurities, such as oils, fats, waxes, and/or greases, are removed from the textile. However, if the textile does not contain natural and/or synthetic impurities that adversely affect embedding and cross-linking, this step can be skipped. The textile can be made from any material, such as, for example, wool, silk, cotton, flax, jute, nylon, polyester, and/or acrylic sources. The textile can be in the form of a weave fabric including a network of natural and/or artificial fibres, in the form of yarn, and/or in the form of a thread.

The detergent can be a non-ionic, such as, for example, esters that contain hydroxyl groups, amines, and/or amides. The amount of detergent used in the souring bath can be between 0.1% and 10% by weight. The liquor-to-good ratio of the scouring bath can range from 25:1 to 50:1, the scouring time can range from 10 minutes to 30 minutes, and the scouring temperature can range from 40° C. to 100° C.

A silica colloidal solution is also obtained (step 104). The silica colloidal solution can be obtained before the textile is scoured, while the textile is scoured, or after the textile is scoured. In some implementations, to obtain the silica colloidal solution, a previously prepared silica colloidal solution can be received, while in other implementations, the silica colloidal solution can be prepared by mixing the chemical constituents of the silica colloidal solution together.

In some implementations, silica can be dispersed in ethanol to prepare the silica colloidal solution. The silica (silicon dioxide; SiO₂) can be, for example, a fumed silica (pyrogenic silica) that is spherical and nanosized. The surface of fumed silica includes hydroxyl groups, hydrogen-bonded hydroxyl groups, and siloxane groups. Because the hydroxyl and hydrogen-bonded hydroxyl groups are hydrophilic, fumed silica is generally hydrophilic even though the siloxane groups are hydrophobic. Nevertheless, the hydrophilic surface of fumed silica can be rendered hydrophobic by reacting the fumed silica with hydrophobic reagents such as, for example, dimethyldichlorosilane (“DDS”; dichlorodimethylsilane; Si(CH₃)₂Cl₂), polydimethylsiloxane (“PDMS”; CH₃[Si(CH₃)₂O]ₙSi(CH₃)₃), and/or hexamethyldisilane (C₆H₁₈Si₂).

In some implementations, the fumed silica can be treated with DDS to render it hydrophobic. The fumed, DDS-treated silica can have a BET surface area of 100 m²/g to 150 m²/g, an average particle size of 15 nm to 100 nm, a pH in four percent aqueous solution of 3.5 to 5.5, a moisture content of less than 0.5%, and a purity of greater than or equal to 99.8% silica nanoparticles. The fumed, DDS-treated silica in ethanol can have an average zeta potential of −31.1 mV, exhibiting moderate stability.

Silica with a concentration of 10 g/L to 50 g/L and, preferably, 40 g/L can be used to prepare the silica colloidal solution. The obtained silica colloidal solution can then be sonicated to reduce the size of the silica nanoparticles.

Next, a cross-linking agent and a catalyst are mixed in deionized water and added to the silica colloidal solution to form a silica padding solution (step 106). A cross-linking agent is used to link the silica nanoparticles to the textile and improve the fastness of the silica nanoparticles to the textile surface. The cross-linking agent is preferably a formaldehyde free cross-linking agent, such as 1,2,3,4-butanetetracarboxylic acid (“BTCA”; C₈H₁₀O₈), citric acid (C₆H₈O₇), succinic acid (butanedioic acid; C₄H₆O₄), maleic acid (C₄H₄O₄), glyoxal (ethanedial; C₂H₂O₂), and/or glutaraldehyde (pentanedial; C₅H₈O₂).

The catalyst can be an alkali metal salt of a phosphorus-containing acid and, preferably, a hypophosphite. The catalyst can be, for example, sodium hypophosphite (“SHP”; sodium phosphinate; NaPO₂H₂) and/or sodium carbonate (Na₂CO₃). In implementations where the textile is cotton, for example, the cross-linking agent can form ester linkage with the cellulose chains of cotton by molecular incorporation of the catalyst in the structure of cross-linking agent. In some implementations, the cross-linking agent and the catalyst can be mixed at a molar ratio ranging from 3:1 to 1:3 and, preferably, 3:2. The mixture of the cross-linking agent and the catalyst can be added to the silica colloidal solution under ultrasound radiation for between one and 60 minutes and, preferably, for 20 minutes. The mixture can also be heated to between 35° C. and 50° C. and, preferably, 40° C. while sonicated to form the silica padding solution.

The textile is then treated with the silica padding solution to form a silica-embedded textile (step 108). In some implementations, the textile is padded in the silica padding solution to a wet pick-up ranging from 50% to 150% and, preferably, 85% to form the silica-embedded textile.

Next, the silica-embedded textile is dried and heat treated (step 110). The silica-embedded textile can be initially dried at, for example, 40° C. for between 10 and 20 minutes. Then, the silica-embedded textile is cured at 120° C. to 200° C. and, preferably, 175° C. for about five minutes so that the fibres of the textile are cross-linked. The heat treatment can optionally be performed under pressure.

### Silica-Embedded Cotton Example

In some implementations, to produce silica-embedded cotton, cotton fabric is scoured with a 0.5% non-ionic detergent in a scouring bath having a liquor-to-good ratio of 40:1 for 30 minutes at 50° C. (corresponding to step 102). Next, 1 litre of a fumed silica solution having a concentration of 40 g/L is dispersed in 666 cc of ethanol (corresponding to step 104). The silica is fumed silica that has been treated with DDS to make it hydrophobic. The silica colloidal solution is then sonicated for 30 minutes at 30° C. to reduce the size of the silica nanoparticles. Next, 1 litre of BTCA having a concentration of 50 g/L and 1 litre of SHP having a concentration of 30 g/L is mixed with the 333 cc of deionized water and is added to the silica colloidal solution to form the silica padding solution (corresponding to step 106). The silica padding solution is sonicated for 20 minutes at 40° C. Next, the cotton fabric is padded with an 85% wet pickup to form the silica-embedded cotton (corresponding to step 108). The silica-embedded cotton is dried at 40° C., then cured at 175° C. for about four minutes, and finally heat treated with an iron at 200° C. for less than a minute (corresponding to step 110).

Surface Morphology

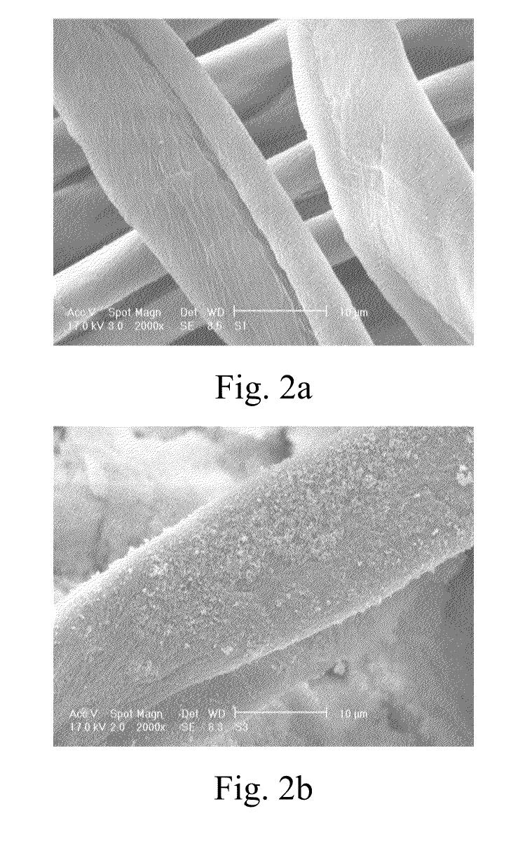

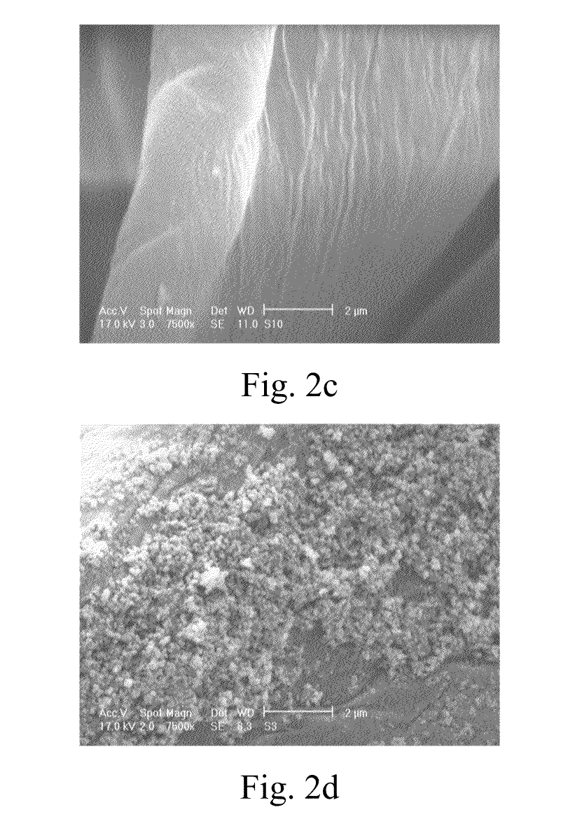

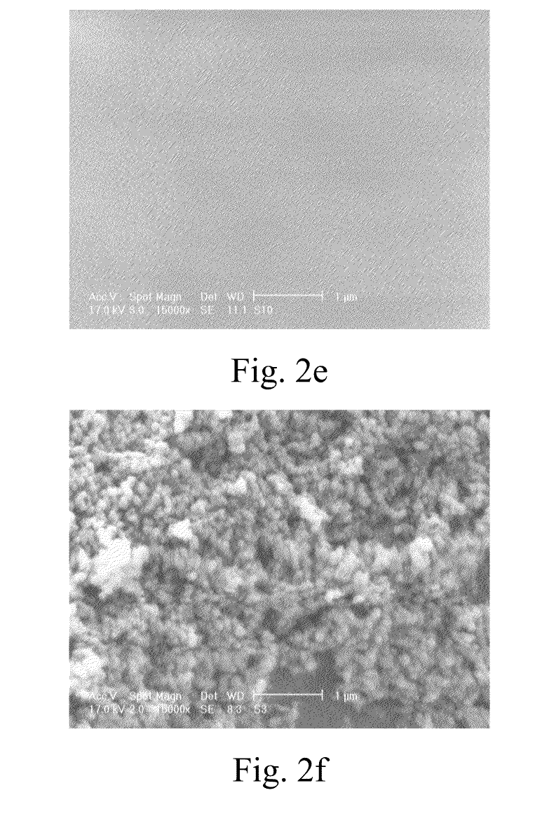

FIGS. 2a-f illustrate scanning electron microscopy (“SEM”) images of raw cotton fibres and silica-embedded cotton fibres prepared according to the EXAMPLE described above at a different magnifications. In particular, FIGS. 2a-b show raw cotton fibres and silica-embedded cotton fibres at a magnification of 2,000 times, respectively. As illustrated, the raw cotton fibres have grooves and fibrils with relatively smooth surfaces, whereas the silica-embedded cotton fibres have rough surfaces covered with nanoparticles. FIGS. 2c-d show raw cotton fibres and silica-embedded cotton fibres at a magnification of 7,500 times, respectively, and FIGS. 2e-f show raw cotton and silica-embedded cotton fibres at a magnification of 15,000 times, respectively. The higher magnification micrographs of FIGS. 2c-f show a well-dispersed layer of silica nanoparticles on the surface of the cotton fibres with relatively low agglomeration. Because silica nanoparticles have high surface free energies due to their hydroxyl groups, they tend to distribute evenly on the surface of the cotton fibers.

Thermogravimetric Properties

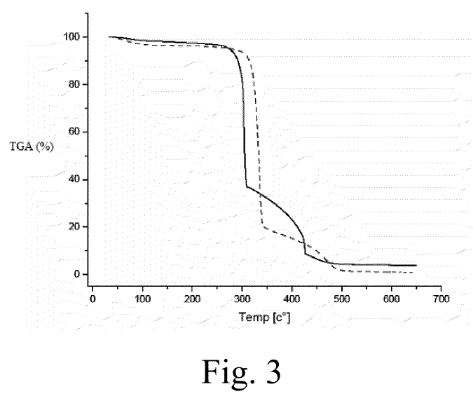

The thermal properties of raw cotton and the silica-embedded cotton prepared according to the EXAMPLE described above were determined by thermogravimetric tests. The temperature of the raw cotton and the silica-embedded cotton was increased from room temperature of about 25° C. to 650° C. at 5° C./min in an oxygen gas atmosphere. Referring to FIG. 3, the change in weight by percentage of the raw cotton, corresponding to the solid line, and the silica-embedded cotton, corresponding to the dashed line, as a function of temperature are illustrated.

As shown in FIG. 3, the change in weight of the two samples is not significant until 300° C. because physical damage is observed in the amorphous region of the cellulose. At temperatures greater than 300° C., the weight loss is significant because of degradation in the crystalline structure of the cellulose, which also results in generation of glucose and combustible gases. At temperatures greater than 400° C., char is produced, releasing water and carbon dioxide and resulting in additional weight loss. Moreover, as shown by the dashed line in FIG. 3, the change in weight of the silica-embedded cotton relative to the raw cotton is lower between about 300° C. and 350° C., i.e., the silica-embedded cotton is more thermally stable in the temperature range in which the crystalline structure of cotton is degraded. The higher stability of the silica-embedded cotton is due to the heat resistance of the silica nanoparticles on the surface of the cotton fibres.

Flammability Properties

The flammability properties of raw cotton and silica-embedded cotton prepared according to the EXAMPLE described above with different silica concentrations were determined by measuring the limiting oxygen index. The limiting oxygen index is the minimum concentration of oxygen that will support combustion and is measured by passing a mixture of oxygen and nitrogen over burning silica-embedded cotton, and reducing the oxygen level until the minimum oxygen level that supports the burning is reached. The limiting oxygen indices for raw cotton and silica-embedded cotton with silica concentrations of 20, 30, and 40 g/L are 17.6%, 19.7%, 19.8%, and 19.9%, respectively.

Although the amount of oxygen necessary to support combustion slightly increases as the concentration of silica is increased in the cotton fabric, silica-embedded cotton requires significantly more oxygen to support combustion. As such, the flammability of the silica-embedded cotton is lower than that of raw cotton. The flame resistance of silica-embedded cotton is due to the polymer-silica nanocomposites formed in the char layers of the cotton, creating a ceramic-like protective layer on the surface of the char layer.

UV-Vis Reflection Properties

The electromagnetic energy reflection properties of raw cotton and silica-embedded cotton prepared according to the EXAMPLE described above with different silica concentrations were measured. The UV-Vis energy is a part of electromagnetic energy which includes, such as radio waves, visible light, infrared light, ultraviolet light, radar, microwaves, x-rays, and/or gamma-rays. To test reflectance, UV-Vis energy was applied to raw cotton and the silica-embedded cotton and the energy reflected from the samples was measured.

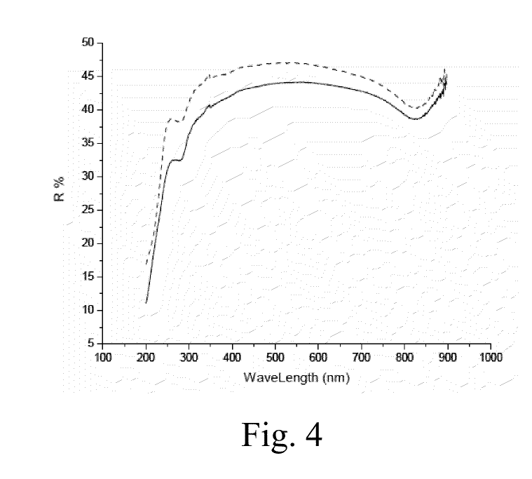

FIG. 4 illustrates the reflectance of UV-Vis energy having a wavelength between 200 nm and 900 nm for raw cotton, corresponding to the solid line, and silica-embedded cotton, corresponding to the dashed line. As shown in FIG. 4, the reflectance of silica-embedded cotton is higher than the reflectance of raw cotton. This is due to the light reflecting from the silica nanoparticles in the spectral range between 300 nm and 800 nm and the reported blue photoluminescence emission of silica.

Water Contact Angle Properties

The water contact angle properties of the silica-embedded cotton prepared according to the EXAMPLE described above with different silica concentrations were measured. Water was used as probe liquid at 23±2° C. and at 65% relative humidity. The contact angles for silica-embedded cotton with silica concentrations of 20 and 40 g/L were 88.3° and 92.5°, respectively. As such, increasing the concentration of hydrophobic silica nanoparticles embedded in cellulose matrix of cotton increased the average water contact angles by over 4°. The increased contact angle is a result of the hydrophobic silica nanoparticles being evenly dispersed in the cellulose matrix, prohibiting water from penetrating into the cotton.

It is to be understood that the implementations are not limited to the particular processes, devices, and/or apparatus described which may, of course, vary. It is also to be understood that the terminology used herein is for the purpose of describing particular implementations only, and is not intended to be limiting. As used in this application, the singular forms “a,” “an,” and “the” include plural referents unless the content clearly indicates otherwise.

Reference in the specification to “one implementation” or “an implementation” means that a particular feature, structure, characteristic, or function described in connection with the implementation is included in at least one implementation herein. The appearances of the phrase “in some implementations” in the specification do not necessarily all refer to the same implementation.

Accordingly, other embodiments and/or implementations are within the scope of this application.

What is claimed is:

1. A method for production of water-resistant silica-embedded textiles, comprising:
obtaining a silica colloidal solution including hydrophobic fumed silica nanoparticles;
mixing a polycarboxylic acid cross-linking agent and a hypophosphite catalyst in deionized water;
adding the mixture of the polycarboxylic acid cross-linking agent and the hypophosphite catalyst to the silica colloidal solution to form a silica padding solution;
treating a textile with the silica padding solution to form a silica-embedded textile; and
curing the silica-embedded textile.

2. The method of claim 1, further comprising scouring the textile using a non-ionic detergent.

3. The method of claim 1, wherein obtaining the silica colloidal solution including the hydrophobic fumed silica nanoparticles comprises dispersing hydrophobic fumed silica nanoparticles in ethanol.

4. The method of claim 3, wherein the concentration of the hydrophobic fumed silica nanoparticle solution is 40 g/L.

5. The method of claim 1, wherein obtaining the silica colloidal solution including the hydrophobic fumed silica nanoparticles comprises obtaining the silica colloidal solution including dimethyldichlorosilane-treated fumed silica nanoparticles.

6. The method of claim 1, wherein the hydrophobic fumed silica nanoparticles have a BET surface area ranging between 100 m²/g and 150 m²/g, an average particle size between 15 nm and 100 nm, and a purity of greater than or equal to 99.8% silica nanoparticles.

7. The method of claim 1, wherein the textile is cotton fabric.

8. The method of claim 1, wherein the polycarboxylic acid cross-linking agent is 1,2,3,4-butanetetracarboxylic acid.

9. The method of claim 1, wherein the hypophosphite catalyst is sodium hypophosphite.

10. The method of claim 1, wherein:
mixing the polycarboxylic acid cross-linking agent and the hypophosphite catalyst in the deionized water comprises mixing 1,2,3,4-butanetetracarboxylic acid and sodium hypophosphite in the deionized water; and
adding the mixture of the polycarboxylic acid cross-linking agent and the hypophosphite catalyst to the silica colloidal solution to form the silica padding solution comprises adding the mixture of the 1,2,3,4-butanetetracarboxylic acid and the sodium hypophosphite to the silica colloidal solution to form the silica padding solution.

11. The method of claim 1, wherein the ratio of the polycarboxylic acid cross-linking agent to the hypophosphite catalyst is 3:2.

12. The method of claim 1, wherein treating the textile with the silica padding solution to form the silica-embedded textile comprises wet padding the textile with the silica padding solution to form the silica-embedded textile.

13. The method of claim 1, wherein curing the silica-embedded textile comprises curing the silica-embedded textile at a temperature greater than or equal to 150° C.

14. The method of claim 1, further comprising sonicating the silica colloidal solution.

15. The method of claim 1, further comprising sonicating the silica padding solution.

16. A water-resistant silica-embedded textile produced by a process comprising the steps of:
obtaining a silica colloidal solution including hydrophobic fumed silica nanoparticles;
mixing a polycarboxylic acid cross-linking agent and a hypophosphite catalyst in deionized water;
adding the mixture of the polycarboxylic acid cross-linking agent and the hypophosphite catalyst to the silica colloidal solution to form a silica padding solution;
treating a textile with the silica padding solution to form a silica-embedded textile; and
curing the silica-embedded textile.

17. A method for production of water-resistant silica-embedded cotton fabrics, comprising:
dispersing dimethyldichlorosilane-treated hydrophobic fumed silica nanoparticles in ethanol to form a silica colloidal solution;
sonicating the silica colloidal solution;
mixing 1,2,3,4-butanetetracarboxylic acid and sodium hypophosphite in deionized water;
adding the mixture of the 1,2,3,4-butanetetracarboxylic acid and sodium hypophosphite to the silica colloidal solution to form a silica padding solution;
sonicating the silica padding solution;
wet padding cotton fabric with the silica padding solution to form silica-embedded cotton; and
curing the silica-embedded cotton at a temperature greater than or equal to 150° C.
